(19) United States
(12) Patent Application Publication
(10) Pub. No.: US 2026/0279983 A1
(43) Pub. Date: Sep. 17, 2026

(54) COATING DEVICE, SYSTEM AND METHOD FOR APPLYING A COATING MEDIUM

(71) Applicant: ERTL Technology GmbH, Aiterhofen (DE)

(72) Inventor: Michael Ertl, Straubing (DE)

(21) Appl. No.: 19/216,381

(22) Filed: May 22, 2025

(30) Foreign Application Priority Data
May 22, 2024 (DE) 10 2024 114 343.6

(51) Int. Cl. H01M 50/124; B05B 12/12

(52) U.S. Cl. CPC H01M 50/1245; B05B 12/122; H01M 2220/20

(57) ABSTRACT

A system (1000) having a coating device (100) for applying a coating medium on a component (10), the coating device (100) comprising a registration feature (102) configured to register at least one geometrical property (h) of the component (10) and at least coating nozzle (104) displaceable in relation to the component (10) and configured to, in particular selectively, apply the coating medium as a function of the at least one geometrical property (h) and as a function of at least one predetermined component-dependent coating criterion based on the at least one geometrical property (h).

This application claims priority to German Patent Application No. 10 2024 114 343.6 filed on May 22, 2024, the disclosure of which is incorporated by reference.

### TECHNICAL FIELD

The invention relates to a coating device, a system having a coating device of this kind, an energy storage medium and a method for applying a coating medium.

### SUMMARY

The precise application of coating media in a specific location is a technical challenge which is important in various industrial sectors. Influencing factors such as environmental conditions can change the properties of the coating medium and complicate the correct application. This is particularly the case in applications where the coating medium has to be applied locally with precision, while surrounding areas should remain free of the coating. Errors during application can impair the functionality of the coated component, which can have negative consequences such as increased rejects.

An example of the complexity and the importance of this process can be found in battery technology, especially in the production of high-voltage storage systems. These consist of individual round cells which are connected via cell belts and joined together in further process steps to form cell clusters. These clusters form the storage foundation of the energy storage medium, which is then made ready for operation by further production steps such as being welded to a cell contacting system and being attached to summation current connectors. To ensure the necessary strength and functionality of the energy storage medium, particularly in electrified transportation applications, the energy storage medium is foamed by introducing a foam into a casing of the energy storage medium, the foam being distributed between the cells and other components and thus filling any gaps. This keeps the cells of the cell cluster and the other components of the energy storage medium in a predetermined position. The foam hardens through a firm form fit, thus giving the energy storage medium the necessary robustness and/or strength for subsequent use.

However, functional tests of the energy storage medium have shown that the cured foam can peel from the surface of the cell shoulder, which leads to the (premature) unusability of the energy storage medium. One way to prevent peeling is to apply an adhesive agent between the cell shoulders and the foam. However, due to the functional composition of the high-voltage storage system, such an adhesive agent must not be applied outside areas of the cell shoulder and, in particular, must not wet other areas of the energy storage medium, such as parts of the cell contacting system and/or the summation current connector, as this would lead to failure and a risk of short-circuiting for the energy storage medium.

Further prior art can be found in DE 10 2018 010 115 A1, DE 10 2007 063 195 A1 and DE 10 2023 128 044 A1.

### DESCRIPTION

It is an object of the invention to indicate a coating device and/or a system for applying a coating medium and/or an energy storage medium and/or a method for applying a coating medium, all of which overcome the challenges mentioned above.

Advantageous embodiments of the invention are the subject matter of the dependent claims. Moreover, any and all combinations of at least two features disclosed in the description, the claims, and/or the figures fall within the scope of the invention. Naturally, the explanations given in connection with the coating device equivalently relate to the system and/or the high-voltage energy storage means and/or the method and vice-versa, without being mentioned separately in its context. In particular, linguistically common rephrasing and/or an analogous replacement of respective terms within the scope of common linguistic practice, in particular the use of synonyms backed by generally recognized linguistic literature, are of course comprised by the content of the disclosure at hand without every variation having to be expressly mentioned. Accordingly, features formulated regarding to the device can be reformulated as features of the method without further ado, without the exact formulation having to be disclosed.

In a first aspect, a coating device is proposed for applying a coating medium to a component, in particular selectively and/or in a spatially resolved manner. The coating device has a registration feature configured to register at least one geometrical property of the component and at least one coating nozzle displaceable in relation to the component and configured to coat only selected areas of a component surface of the component with the coating medium as a function of the at least one geometrical property and as a function of at least one predetermined, component-dependent coating criterion based on the at least one geometrical property.

The at least one coating nozzle can also preferably be configured to apply the coating medium as a function of an application speed at which the at least one coating nozzle moves in relation to the component or rather a component surface. The application speed can, for example, be used as a three-dimensional, vectorial variable when actuating the at least one coating nozzle. The application speed can also be dynamically variable as a function of at least one acceleration in a degree of mobility of the at least one coating nozzle. The application speed can preferably be measured and/or registered by speed sensors attached to the coating device. Alternatively, acceleration sensors can also be used to measure acceleration in at least one degree of mobility. The respective application speed can then be determined at least partially over time from a registered acceleration.

The geometrical property can be, for example, a height and/or a height profile of a component surface in relation to the registration feature. The geometrical property can be, for example, a height of a component surface in relation to the at least one coating nozzle, in particular if a geometrical relationship between the registration feature and the at least one coating nozzle is known or can be clearly determined, preferably if a distance between the registration feature and the at least one coating nozzle is known, in particular with respect to the at least one geometrical property. The geometrical property may also have a width and/or a width profile and/or a length and/or a length profile which can be unambiguously determined by the registration feature, in particular in relation to the at least one coating nozzle. The geometrical property can also be another geometrical profile of at least one component surface.

The at least one coating nozzle is preferably movable in relation to the component and/or a component surface in at least one, preferably at least two degrees of mobility. Particularly preferably, the at least one coating nozzle can also be rotatable in at least one degree of mobility. If the geometrical property is a height and/or a height profile of the component in relation to the registration feature and/or in relation to the at least one coating nozzle, the at least one coating nozzle can preferably be movable in at least one direction of movement orthogonal to the height.

The coating criterion can be determined as a function of the component and/or the areas of the component to be coated. The coating criterion can also change in sections with regard to a surface of the component to be coated. This depends largely on the geometric nature and complexity of the component surface to be coated. For example, the component surface to be coated can be divided into grids, a different coating criterion being able to be selected for at least two of the grids. Particularly preferably, the choice of coating criterion can be used to ensure only selected areas of the component surface(s) are coated with the coating medium. The registration feature also makes this possible in particular during online operation of the coating device. In this manner, the registration feature can be used to optically sample and/or detect the at least one geometrical property of the component and/or the component surface preferably in real-time predictive manner and compare it to the at least one coating criterion. Only if the coating criterion is fulfilled is the coating medium applied in a spatially resolved manner, as a function of the geometrical property. The coating criterion can be an absolute limit value, preferably having a determinable tolerance interval. The coating criterion can have a limit interval. The coating criterion can also be chosen in such a manner that it specifies which areas of the component should not be coated as a function of the geometrical property. For example, the at least one coating nozzle can only be actuated for application if the at least one coating criterion is not fulfilled. A negative formulation of this kind of the coating criterion is also covered by the present disclosure.

In the present case, the coating medium can be applied with a precision of at least 0.1 mm, since the at least one coating nozzle is actuated as a function of the at least one geometrical property only when the at least one coating criterion is met and/or is opened and/or released for application of the coating medium. In this manner, it is possible in the present case to coat only predetermined partial areas of the component, whereas other areas remain free of the coating medium. This prevents the component from becoming inoperable due to an otherwise possibly defective, applied coating. This reduces the number of rejects. Furthermore, the component can only be equipped with the function associated with the coating where it is functionally intended. Furthermore, coating medium can be saved due to the spatially resolved coating, as areas which do not necessarily need to be coated, for example, remain free of coating.

In a further aspect, it is proposed that the registration feature has a laser-based triangulation sensor for sampling a height of the component in relation to the registration feature and/or the coating nozzle, or a laser profile sensor for registering a height profile of the component in relation the registration feature and/or the coating nozzle.

A laser-based triangulation sensor for registering a height is preferably a measuring instrument which uses the properties of laser light to determine the height or distance information of the component and/or a component surface, generally of an object. The functional principle is based on triangulation, in which a position of a point in space is computed from an angle and a distance to a benchmark. A laser-based triangulation sensor preferably emits a laser beam which strikes the component to be measured and is reflected by it. The reflected beam is registered by a detector in the triangulation sensor. The position at which the reflected beam strikes the detector depends on the distance between the object and the sensor. The geometric relationships in the arrangement of the laser source, detector and component allow the height or distance of the component in relation to the triangulation sensor to be calculated precisely.

A laser profile sensor for registering a height profile is a measuring instrument based on the technique of optical triangulation, similar to a single triangulation sensor but with additional functions. It is used to register a profile of a surface along a line instead of only measuring a single point of the component surface. This makes it possible to create detailed 2D or 3D profiles and dimensions of the component surface. The laser profile sensor preferably emits a laser beam which is projected as a line over the component to be measured. This is preferably done using special optics which expand the laser beam from a point into a line. The laser beam strikes the surface of the object and is reflected differently depending on the composition and shape of the surface of the component. A high-resolution camera or detector sensor registers the light reflected by the component surface. The position at which the reflected light strikes the sensor varies depending on the height and contour of the surface. The data on the positions of the reflected light is analyzed to create an accurate profile of the surface along the line. The geometric relationships between the sensor, the laser line and the detector positions enable the calculation of the height profile of the surface of the component in relation to the laser profile sensor. The laser profile sensor can also be understood as a laser line sensor.

As a function of the at least one coating criterion, which can be determined as a function of the registered distance and/or profile of the component, only areas of the component surface for which the coating criterion is fulfilled are coated with the coating medium. The registered distance from the component to the registration feature preferably serves as a trigger for actuating a valve assigned to the at least one coating nozzle. Control software developed for this application is used to actuate the valve of the coating nozzle, in particular while also taking into account the current (vectorial) application speed at which the at least one coating nozzle moves in relation to the component and/or the component surface. Particularly preferably, mechanical and/or production-related and/or control-related tolerances of the valve of the at least one coating nozzle can be adapted via adjustable and/or selectable offset parameters, in particular individually for each nozzle and/or valve.

In particular, the laser profile sensor, but also the laser-based triangulation sensor, has/have the advantage that the component can be measured inline, i.e., during production and/or completion of the component, with regard to the at least one geometrical property, without the need for an additional production step. Preferably, the registration feature can be used to generate and/or calculate an inline coating stencil based on the geometrical property and the coating criterion. The valve of the at least one coating nozzle for wetting a predetermined partial area and/or section of a surface of the component is then preferably actuated on the basis of this inline coating stencil. The inline coating stencil can also be understood as a coating stencil that can be dynamically adjusted, in particular during the application process of the coating medium.

In a further aspect, it is proposed that the registration feature has at least one camera, wherein the at least one camera is configured to register several, in particular more than two, benchmarks on the component and/or on a surface or at least one surface section of the component in relation to the registration feature and/or the coating nozzle. The registration feature is configured to compare the registered benchmarks to corresponding reference points of a predetermined, in particular component-dependent coating stencil and, should at least one of the benchmarks deviate from a respective reference point, to, preferably dynamically, adjust the coating stencil at least partially based on the deviation, in particular to at least partially stretch or stretch the coating stencil.

The registration feature can be used to measure and evaluate the component and/or at least one surface section of the component in such a manner that a comparison to a coating stencil, in particular a component-specific coating stencil, is possible. The coating stencil indicates, for example, which areas of a component should ideally be coated, while areas not to be coated are masked by the coating stencil. The coating stencil is preferably generated on the basis of idealized component conditions (a production without tolerances) individually for a component surface or at least one surface section to be coated. In the case of an energy storage medium which has several cells organized into cell clusters, where only cell shoulder areas are to be coated, the coating stencil indicates the areas in an ideally produced energy storage medium where the respective cell shoulder areas to be coated are located. All other areas, such as contacting features or intermediate areas between the cells, are masked by the coating stencil so that they are not coated. By comparing reference points on the coating stencil to the registered benchmarks, it is possible to determine how the component differs from an ideal component due to real production tolerances. This makes it possible to determine how a component-specific coating stencil differs from an ideal coating stencil. Preferably, the benchmarks are registered and compared to the respective reference points segment by segment and/or section by section. The coating stencil and the component surface can, for example, be divided into corresponding grids, benchmarks being able to be registered for each grid and the respective benchmarks being able to be compared to the respective grid-specific reference points. In this manner, it is possible to determine with spatial resolution in which sections an image of the surface of the component deviates from the idealized print template. If a deviation is detected, the print template can then be adapted to the geometric conditions of the respective component, preferably on a grid-by-grid basis. The adjustment can be made by at least partially stretching and/or shrinking the printing template. Depending on the application, the printing template can be two-dimensional or three-dimensional.

In a further aspect, it is proposed that the registration feature is configured to detect the at least one geometrical property in real-time predictive manner during the coating process, or wherein the registration feature is configured to detect the at least one geometrical property prior to the coating process.

A surface of the component to be coated, for which the at least one geometrical property for applying the coating medium is to be determined, can preferably be determined in advance in real time during the coating process by the registration feature. This means that the at least one geometrical property is preferably determined for areas of the component for which the coating has not yet been applied, but may be applied immediately afterwards. Depending on the computing power of the registration feature and/or the coating device, the geometrical property can be determined only a few milliseconds to seconds in real-time predictive manner for this area before the relevant area is coated. In other cases, it can be advantageous if the geometrical property is determined in advance for the component as a whole before the component is coated and, if necessary, a component-specific print template is generated.

In a further aspect, it is proposed that the coating device is configured to compare the predetermined coating criterion to the at least one registered geometrical property, preferably in real time or in real-time predictive manner in a predetermined manner, and to actuate the at least one coating nozzle for coating the component only when the geometrical property registered by the registration feature corresponds to or fulfills the predetermined coating criterion.

The comparison can be carried out, for example, by comparing the registered geometrical property to the at least one coating criterion. If a matching criterion is fulfilled, a release for the at least one coating nozzle can be facilitated by the control system so that the component can be coated, in particular selectively, in the surface area for which the matching criterion is fulfilled.

In a further aspect, it is proposed that the predetermined coating criterion has a reference height of the component in relation to the registration feature, the reference height being able to have a tolerance, and/or to the coating nozzle or has another component-dependent distance with a tolerance, including between reference points.

The reference height can be a height and/or a width and/or a length, the height and/or the width and/or the length preferably being provided with a tolerance interval. For example, the registration feature can be used to determine a height of the component surface in relation to the registration feature at least for several points on the component surface, preferably with high resolution. The coating criterion can, for example, have a target height ± a predetermined tolerance. If the registration feature measures an actual height for a point on the component surface which corresponds to the target height ± the predetermined tolerance, the coating criterion is fulfilled, meaning the at least one coating nozzle can be released for applying the coating medium for this point on the component surface. The at least one coating nozzle can therefore be actuated to apply the coating medium.

In a further aspect, it is proposed that the coating device further has a robotic arm or a displacement portal, wherein the at least one registration feature and/or the at least one coating nozzle is disposed on the robotic arm or the displacement portal, and wherein the robotic arm or the displacement portal is configured to displace the at least one registration feature and/or the at least one coating nozzle in relation to the component in at least one degree of mobility.

Preferably, the at least one cleaning nozzle can be displaced by the robotic arm or the displacement portal along at least two degrees of mobility, for example parallel to a surface of the component. A complex movement of the at least one coating nozzle is also possible and may even be preferred, for example, if the surface of the component is complex. The coating device can preferably have several coating nozzles, which can, for example, be disposed in a row and/or at a distance from each other on a cantilever arm of the robotic arm or the displacement portal. The coating nozzles can, for example, be designed as a nozzle bar, which can then be displaced by the robotic arm or the displacement portal along at least one displacement direction and/or in at least one degree of mobility. With a nozzle bar of this kind, it is preferable if each individual coating nozzle can be individually actuated and/or opened and/or closed. Preferably, an actuatable valve, for example a solenoid control valve, is assigned to each coating nozzle for this purpose.

A robotic arm is a type of mechanical arm which can perform functions similar to a human arm. The robotic arm can be part of a larger robotic system. The robotic arm preferably has several joints which enable movements in several degrees of mobility. The robotic arm can have an end effector on which preferably the at least one coating nozzle and preferably also the registration feature is/are disposed.

A displacement portal, also known as a portal robot, is a structure which allows performing movements along several axes and/or in several degrees of mobility with high precision. This system is equipped with one or more rails on which sliders or similar components can move horizontally and vertically. The axes are preferably referred to as portal axes.

In a further aspect, it is proposed that the coating medium acts as an adhesive agent between the component and another part, such as a foam and/or a stabilizing agent for stabilizing parts of the component. Particularly preferably, the coating medium has an ultraviolet varnish.

An adhesive agent is a substance which is used to improve the adhesion between two materials that may not bond well together. In the present case, the coating medium preferably serves as an adhesive agent between a surface material, preferably a plastic, of the component and the material of the stabilizer. An ultraviolet coating, also known as UV coating, is a special surface coating material which hardens under the influence of ultraviolet light. UV coatings are based on a formulation of monomers and oligomers activated by photoinitiators. When the coated surfaces are exposed to UV light, the photoinitiators trigger a chemical reaction which leads to very rapid polymerization. This process transforms the liquid coating into a solid, durable coating. Hardening under UV light is fast, which speeds up production processes and saves energy, as no long drying times are required as is the case with conventional coatings.

In a further aspect, it is proposed that the coating device has a device for temperature compensation of at least one temperature-dependent property of the coating medium, in particular a flow rate.

Preferably, the coating device can have a temperature sensor for this purpose, which registers a temperature of the environment and/or a surface temperature of the component, possibly also with spatial resolution. The physical properties of the coating medium can be used to determine its reaction to a change in temperature, the functional relationships being able to be used to actuate the at least one coating nozzle. If, for example, the temperature dependence of the flow rate of the coating medium is known, the measured temperature can be used to determine the time and flow distance covered by the coating medium at standstill. Using this information, the at least one coating nozzle can preferably receive control information to adapt the coating of the component surface in such a manner that only a predetermined area of the component surface is coated, while taking into account the flow velocity. Another temperature-dependent property can be the viscosity of the coating medium.

In a further aspect, a system is proposed. The system has a coating device according to one of the aspects described herein and a component. The component is preferably at least a part of a (high-voltage) energy storage medium and has a cell cluster having a plurality of energy storage cells, a cell contacting feature and a summation current connector.

The (high-voltage) energy storage medium is preferably suitable for use in a vehicle. The (high-voltage) energy storage medium can also be a stationary energy storage medium. The term "high-voltage" preferably refers to an energy storage medium which has a total output voltage of at least 250 volts, preferably at least 400 volts, particularly preferably at least 800 volts.

The component can be part of an energy storage medium system. It can be a component which is used in different types of energy storage mediums, such as batteries or capacitors. A cell cluster having multiple energy storage cells describes a cluster or group of energy storage cells which work together to store and provide energy. The cell contacting feature is preferably used to electrically connect the individual energy storage cells. It enables the transfer of electrical current between the cells and ensures proper distribution of the electrical load. A summation current connector connects the currents of the individual cells to form a total current. The summation current connector is responsible for ensuring that the combined current of the individual cells is efficiently transmitted to the external loads or other components of the energy storage medium system. The energy storage medium is stabilized by a stabilizer, for example a foam or a resin, for reasons of stability, rigidity and/or strength. A UV coating is preferably applied as an adhesive agent between the cells and/or a respective cell shoulder of a respective cell and the stabilizer, in particular the foam. The precise application of this UV coating as an adhesive agent to the surfaces of the cell shoulder to be wetted by means of the at least one coating nozzle, which preferably has a jet valve, is made possible in the present case by the coating device. It becomes possible by the at least one geometrical property being determined by the registration feature, in particular selectively, and the cells in the cell shoulder area being coated only where the geometrical property fulfills the predetermined coating criterion. Wetting outside the cell shoulders would lead to rejection of the energy storage medium. Due to the tolerances of the entire high-voltage storage system, wetting the cell shoulders using a fixed coating stencil and/or a fixed print template is not possible, as this would lead to impermissible wetting of summation current connectors, gaps, ribbon cables, etc. This can be prevented by the coating device.

In a further aspect, it is proposed that the system further has a drying device for at least partially drying the coating medium.

The drying device is preferably an ultraviolet-light-based drying device. The drying device can be designed for pre-drying and/or hardening the coating medium. The drying device can also be a part of the coating device. For example, the coating device can have a drying device for pre-drying the coating medium immediately after application by the at least one coating nozzle in order to thus prevent the coating medium from flowing on the component surface immediately after application of the coating medium, for example. The drying device can also be used for hardening the coating medium and can be disposed as an additional feature in the production chain after the coating device. The drying device can also be positioned downstream of the coating device. For this purpose, the drying device can be disposed on the robotic arm or the displacement portal. The UV lamps of the drying device are preferably equipped with an intensity control, which checks the intensity of the lamps before each application in order to achieve an optimum drying result.

In a further aspect, it is proposed that the system further has a feature for measuring a layer thickness of the coating medium after application. This coating thickness measurement is preferably used for quality control after application of the coating medium.

In a further aspect, an energy storage medium for a vehicle is proposed. The energy storage medium has at least one cell cluster having several energy storage cells, a cell contacting feature and a summation current connector, wherein at least partial areas of the energy storage cells, in particular only cell shoulder areas of the energy storage cells, are coated with a coating medium, in particular an ultraviolet coating, which is applied by a coating device as described herein.

The energy storage medium can also have other components. The energy storage medium is only coated with the coating medium in places where the function of the energy storage medium cannot be impaired by the coating medium. For example, the coating medium must not get into spaces between cells, as this could lead to a short circuit when the energy storage medium is in operation. The coating medium must not get onto the cell contacting feature and/or the summation current connector, as this could lead to faulty contacting and possibly to a short circuit or failure of the energy storage medium.

In a further aspect, it is proposed that the energy storage medium further has a casing in which the at least one cell cluster, the cell contacting feature and the summation current connector are at least partially disposed, and a stabilizing medium which is inserted in the casing in order to stabilize the energy storage medium. The coating medium acts as an adhesive agent between the energy storage cells and the stabilizing medium in order to thus prevent or at least minimize a peeling of the stabilizing medium off the energy storage cells during a high-performance operation of the energy storage medium.

In a further aspect, it is proposed that the stabilizing medium comprises a reactive foam, in particular a two-component foam, or a resin. Other stabilizers are also generally conceivable.

In a further aspect, a method for applying a coating medium to a component is proposed. The method includes the steps of registering at least one geometrical property of the component by means of a registration feature and of only selectively coating a component surface of the component via the coating medium as a function of the at least one geometrical property and as a function of at least one predetermined component-dependent coating criterion based on a geometrical property via at least one coating nozzle displaceable in relation to the component.

The method may further include the step of pre-drying the coating medium by a drying feature after application of the coating medium. The method may further comprise hardening the coating medium by a drying feature. The at least one geometrical property can be registered inline with the application of the coating medium, but in real-time predictive manner.

The coating medium can preferably be discharged from the at least one coating nozzle at a discharge frequency of 100 Hz to 2000 Hz. The at least one geometrical property is registered by the registration feature preferably with a resolution, in particular a dot-to-dot grid spacing, of 0.1 mm. A higher or lower resolution is also conceivable. A displacement speed of the at least one coating nozzle is 100 mm/s to 2000 mm/s and preferably results from the discharge frequency and the dot-to-dot grid spacing. The coating medium can preferably be preheated in a pre-circuit and/or in the at least one coating nozzle. The at least one coating nozzle and/or the coating device can have at least one heating feature for this purpose. An application distance between line-by-line application of the coating medium is preferably greater than or equal to 0.2 mm, for example 0.4 mm, 0.6 mm or 0.8 mm or any other intermediate value, from line to line. The application distance is preferably less than 2 mm. Preferably, the coating device is configured to coat at least 85 % of the component surface to be coated with the coating medium. The robotic arm or the displacement portal can be moved at a displacement speed of at least 5 m/min and/or 93 mm/s. The coating medium can be dried and/or hardened by a drying feature, preferably at a distance of 100 mm from the component surface. The coating device can preferably have a leading and/or trailing distance of at least 100 mm for drying and/or hardening.

It will be understood that the embodiments and exemplary embodiments mentioned above and to be explained below can be formed not only individually, but also in any combination with each other, without departing from the scope of the present invention. It is also understood that the embodiments and exemplary embodiments mentioned above and to be explained below relate in an equivalent or at least similar manner to all embodiments of the invention, without being mentioned separately in each case.

### BRIEF DESCRIPTION OF THE DRAWINGS

Embodiments of the invention are schematically shown in the drawings and are described exemplarily in the following.

FIG. 1 shows a schematic view of a system having a coating device according to an exemplary embodiment.

FIG. 2 shows a schematic view of a system having a coating device according to an exemplary embodiment.

FIG. 3 shows a schematic view of a system having a coating device according to an exemplary embodiment.

FIG. 4 shows a schematic view of a system having a coating device according to an exemplary embodiment.

FIG. 5 shows a schematic view of a component surface of component from above.

FIG. 6 shows a schematic view of a system having a coating device according to an exemplary embodiment.

FIG. 7 shows a schematic view of a component surface of a component from above.

FIG. 8 shows a schematic flow chart of an exemplary embodiments of the method at hand.

### DETAILED DESCRIPTION

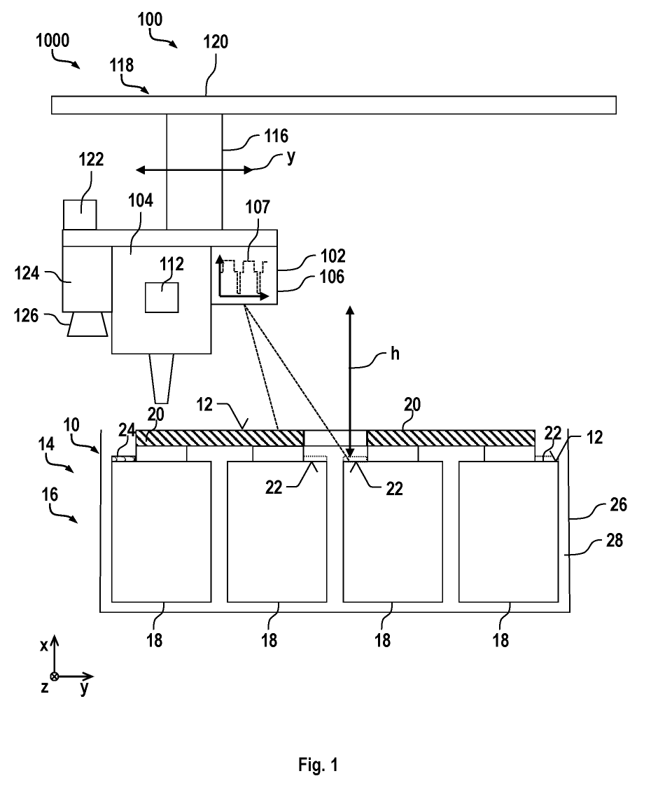

FIG. 1 shows a system 1000 for applying a coating medium on a component 10 by means of a coating device 100.

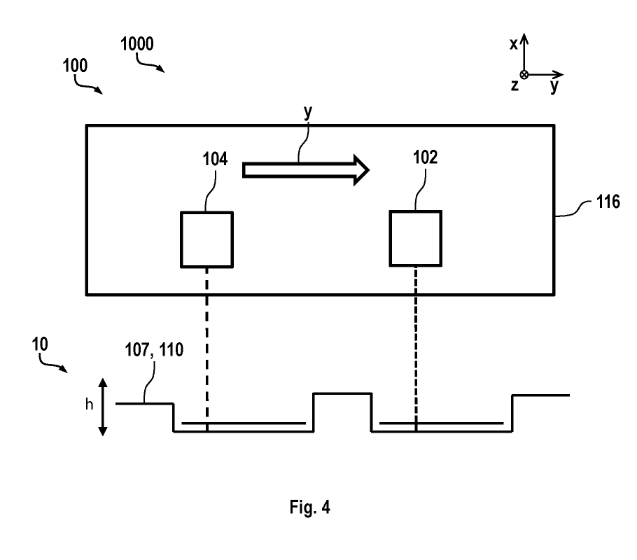

For this purpose, the coating device 100 has a registration feature 102 which is configured to register at least one geometrical property h of the component 10. In the present case, the registration feature 102 is configured to register a height of a component surface 12 in relation to the registration feature 102. The registration feature 102 can determine the geometrical property h at an acute angle to the component surface 12 (see FIGS. 1-3) or orthogonally to the component surface 12 (see FIG. 4).

The coating device 100 further comprises at least one coating nozzle 104 which is movable in relation to the component 10 and which is configured to, in particular selectively, apply the coating medium as a function of the at least one geometrical property h and as a function of at least one predetermined, component-dependent coating criterion based on the at least one geometrical property h. The coating medium preferably acts as an adhesive agent between a surface of the component 10 and at least one further component of the system 1000.

The coating device 100 is configured to compare the predetermined coating criterion, preferably in real time, to the at least one registered geometrical property h, and to control the coating nozzle 104 for coating the component 10, for example by opening a valve, only if the geometrical property h registered by the registration feature 102 matches or fulfills the predetermined coating criterion. The coating criterion can, for example, have a target height together with a predetermined tolerance of ± 0.1 mm, for example. Only if an actual height registered by the registration feature 102 matches the target height and/or is within the tolerance interval is the at least one coating nozzle 104 actuated for coating. In other cases, the coating criterion can also be more complex, for example having a target arrangement of reference points in relation to each other on the component surface 12, the target arrangement being compared to an actual arrangement of benchmarks which are registered by the registration feature 102.

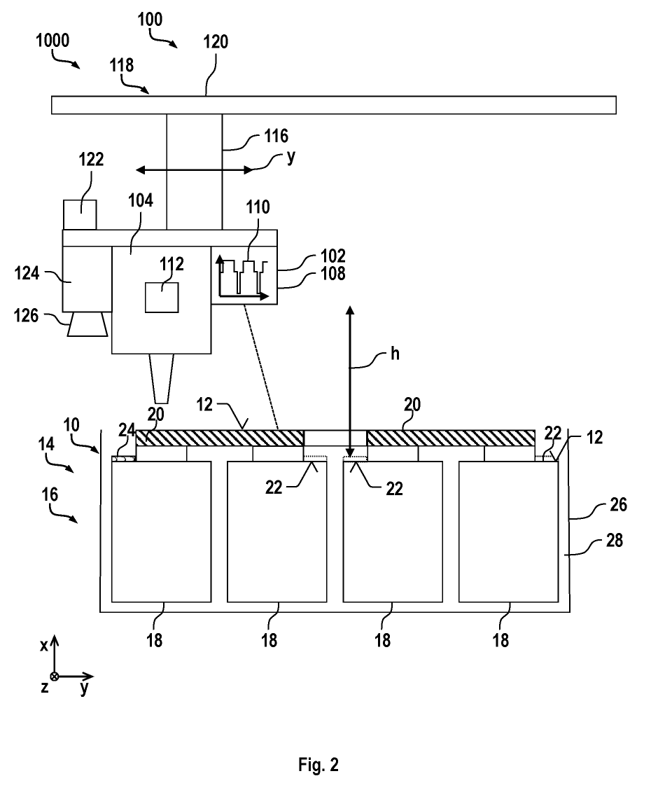

The registration feature 102 can, for example, have a laser-based triangulation sensor 106 for sampling a height 107 (which corresponds to the geometrical property in the present case) of the component 10 or rather the component surface 12 in relation to the registration feature 102, in particular dot by dot. Alternatively, the registration feature 102 can have a laser profile sensor 108 (see FIG. 2) for line-by-line registration of a height profile 110 of the component 10 in relation to the registration feature 102.

The registration feature 102 can have an evaluation device 112 for evaluating the registration information. The evaluation device 112 may also be provided outside the registration feature 102 and may, for example, be part of the coating device 100.

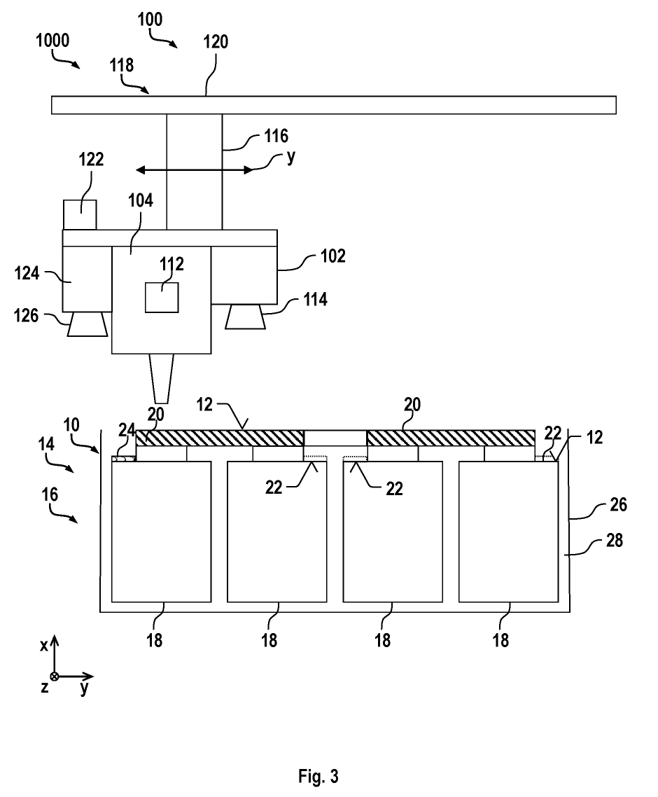

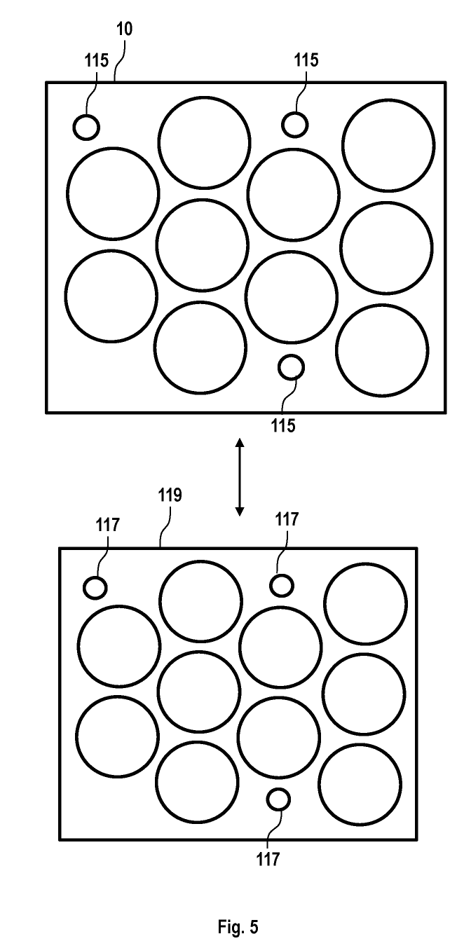

In other embodiments, see for example FIGS. 3 and FIG. 5, the registration feature 102 may comprise a camera 114. The camera 114 is configured to register several benchmarks 115 on the component 10 or rather on the component surface 12 in relation to itself. The registration feature 102, in particular by the evaluation device 112, is configured to compare the registered benchmarks 115 to corresponding reference points 117 of a predetermined coating stencil 119 and, in the event of a deviation between at least one of the benchmarks 115 and a relevant reference point 117, to adapt the coating stencil 119 at least partially on the basis of the deviation, in particular to stretch or shrink it at least partially. In the case of the example shown in FIG. 5, for example, the coating stencil 119 would be stretched in order to be dynamically adapted to the surface 12 of the component 10.

As can already be seen schematically from FIGS. 1 to 3 due to the arrangement of the components along the direction of a traversing axis y, the registration feature 102 is configured to detect the at least one geometrical property h during the coating process, in particular in advance. Alternatively, the registration feature can also be configured to determine the at least one geometrical property h before the coating process, which is not shown in the Fig.

The registration feature 102 and the at least one coating nozzle 104 are presently disposed on a portal arm 116 of a displacement portal 118. The displacement portal 118 has a linear guide 120 along which the portal arm 116 is movable at least in the displacement direction y. As an alternative to a displacement portal, a robotic arm can also be used. The displacement portal 118 is configured to displace the at least one registration feature 102 and the at least one coating nozzle 104 in relation to the component 10 in at least one degree of mobility, in this case at least along the displacement direction y.

The coating device 100 further has a device for temperature compensation 122, in the present case comprising a temperature sensor. At least one temperature-dependent property of the coating medium can be determined and monitored by the device for temperature compensation 122 and, in particular, the at least one coating nozzle 104 can also be actuated on the basis of this temperature-dependent property. The temperature-dependent property can in particular be a flow rate of the coating medium.

The system 1000 may preferably also have a drying device 124 for (pre-)drying or hardening the coating medium. The drying device 124 may preferably have at least one UV lamp 126.

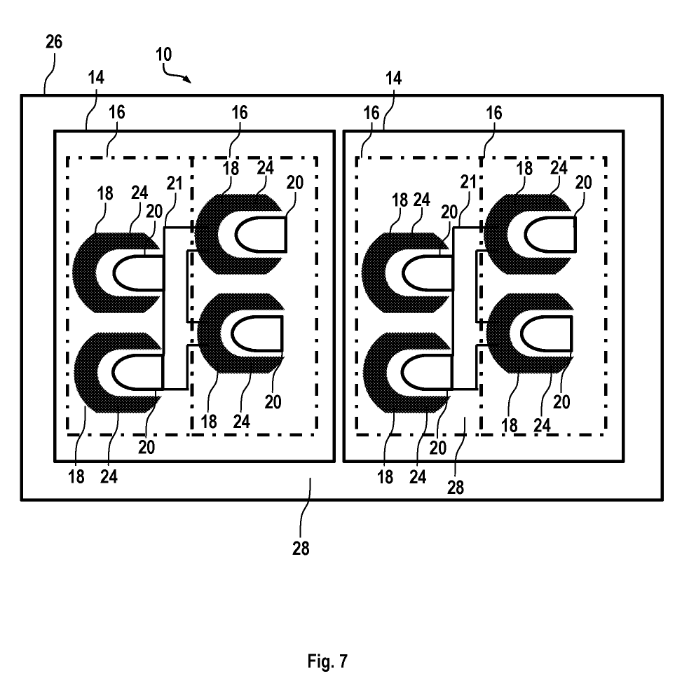

The component 10 is preferably at least part of an energy storage medium 14. The component 10 has, for example, several components. For example, the component 10 has at least one cell cluster 16 having several energy storage cells 18 and a cell contacting feature 20 and a summation current connector 21 (see FIG. 7). The coating device 104 is configured to coat only partial areas of the energy storage cells 18, in particular only cell shoulder areas 22 of the energy storage cells 18, with the coating medium, which is indicated by the reference numeral 24 in FIGS. 1-3. After coating, however, the cell contacting feature 20 and the summation current connector are preferably essentially free of coating medium. FIGS. 1-3 also show cell shoulder areas 22 which have not yet been coated with the coating medium, yet are still to be coated. This is indicated schematically in each case by a dashed box. In the present case, the coating medium is a UV coating. However, other coatings or primers are also conceivable, so that this is not to be understood as limiting.

The component 10 and/or the energy storage medium 14 preferably has a casing 26 in which the at least one cell cluster 16, the cell contacting feature 20 and the summation current connector are at least partially disposed. The component 10 and/or the energy storage medium 14 also has a stabilizing medium 28, which is inserted into the casing 26 to stabilize the energy storage medium 14. The coating medium acts as an adhesive agent between the energy storage cells 18 and the stabilizing medium 28, in particular in the cell shoulder area 22, in order to thus prevent or at least minimize peeling of the stabilizing medium 28 off the energy storage cells 18, in particular during high-performance operation of the energy storage medium 14. The stabilizing medium 28 preferably comprises a reactive foam or a resin.

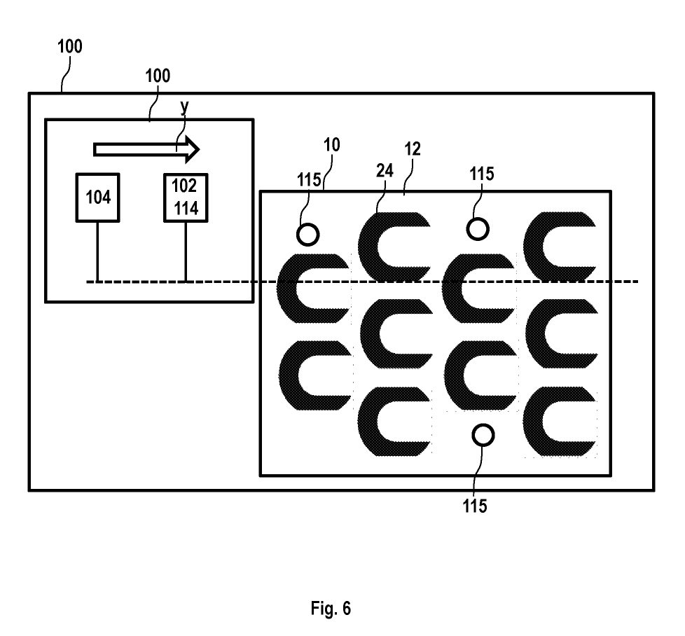

FIG. 6 shows a schematic view of an exemplary embodiment of the system 1000. The registration feature 102 is a camera 114 which generates an optical image of the component surface 12 and registers the benchmarks 115. The benchmarks 115 can be used to determine the position of the areas 24 to be coated, in this case the cell shoulder areas. Via the comparison to reference points on a coating stencil (not shown in FIG. 6), the coating nozzle 104 can then be actuated in order to coat the areas 24 still to be coated. All areas of the component surface 12 outside the areas 24 are preferably uncoated.

FIG. 7 shows a schematic top view of a component surface 12 of the component 10 designed as the energy storage medium 14. FIG. 7 shows several cell clusters 16 with the cell contacting features 20 and summation current connectors 21. Furthermore, the cell shoulder areas 24 to be coated with the coating medium are shown schematically. In the exemplary embodiment shown, several energy storage media 14 are disposed in the casing 26 and stabilized in relation to the casing 26 and to each other by the stabilizing medium 28.

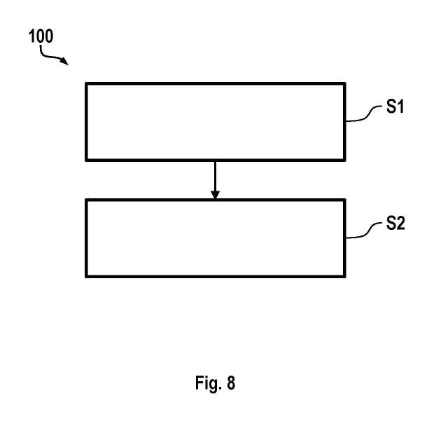

FIG. 8 shows a flowchart of an exemplary embodiment of the present method, which can be carried out by the coating device 100. In a step S1, the method includes registering at least one geometrical property h of the component 10 by means of a registration feature 102 and, in a step S2, coating the component 10, in particular selectively, with the coating medium as a function of the at least one geometrical property and as a function of at least one predetermined, component-dependent coating criterion based on the at least one geometrical property by means of at least one coating nozzle 104 which is movable in relation to the component 10.

### LIST OF REFERENCE NUMERALS

10 component

12 component surface

14 energy storage

16 cell cluster

18 energy storage cells

20 cell contacting feature

21 summation current connector

22 cell shoulder area

24 cell shoulder area still to be coated

26 casing

28 stabilizing medium

100 coating device

102 registration feature

104 coating nozzle

106 triangulation sensor

107 height

108 laser profile sensor

110 height profile

112 evaluation device

114 camera

115 benchmarks

116 portal arm

117 reference points

118 displacement portal

119 coating stencil

120 linear guide

122 device for temperature compensation

124 drying device

126 UV lamp

1000 system

h geometrical property

y travel direction

x direction

z direction

1. A coating device (100) for applying a coating medium on a component (10), the coating device (100) comprising a registration feature (102) configured to register at least one geometrical property (h) of the component (10) and at least one coating nozzle (104) displaceable in relation to the component (10) and configured to coat only selected areas of a component surface of the component (10) with the coating medium as a function of the at least one geometrical property (h) and as a function of at least one predetermined, component-dependent coating criterion based on the at least one geometrical property (h).

2. The coating device (100) according to claim 1, wherein the registration feature (102) has a laser-based triangulation sensor (106) for sampling a height (107) of the component (10) in relation to the registration feature (102) and/or the coating nozzle (104), or a laser profile sensor (108) for registering a height profile (110) of the component (10) in relation the registration feature (102) and/or the coating nozzle (104).

3. The coating device (100) according to claim 1, wherein the registration feature (102) has a camera (114), wherein the camera (114) is configured to register several benchmarks (115) on the component (10) in relation to the registration feature (102) and/or the coating nozzle (104), wherein the registration feature (102) is configured to compare the registered benchmarks (115) to corresponding reference points (117) of a predetermined coating stencil (119) and, should at least one of the benchmarks (115) deviate from a respective reference point (117), to adjust the coating stencil (119) at least partially based on the deviation.

4. The coating device (100) according to claim 1, wherein the registration feature (102) is configured to detect the at least one geometrical property (h) in real-time predictive manner during the coating process, or wherein the registration feature (102) is configured to detect the at least one geometrical property (h) prior to the coating process.

5. The coating device (100) according to claim 1, wherein the coating device (100) is configured to compare the predetermined coating criterion to the at least one registered geometrical property (h), preferably in real time, and to actuate the at least one coating nozzle (104) for coating the component (10) only when the geometrical property (h) registered by the registration feature (102) corresponds to or fulfills the predetermined coating criterion.

6. The coating device (100) according to claim 1, wherein the predetermined coating criterion has a reference height of the component (10) in relation to the registration feature (102), the reference height having a tolerance, and/or to the coating nozzle (104) or has another component-dependent distance with a tolerance, including between reference points.

7. The coating device (100) according to claim 1, wherein the coating device further has a robotic arm or a displacement portal (118), wherein the at least one registration feature (102) and/or the at least one coating nozzle (104) is disposed on the robotic arm or the displacement portal (118), and wherein the robotic arm or the displacement portal (118) is configured to displace the at least one registration feature (102) and/or the at least one coating nozzle (104) in relation to the component (10) in at least one degree of mobility.

8. The coating device (100) according to claim 1, wherein the coating medium acts as an adhesive agent between a component surface (12) or the component (10) and another part.

9. The coating device (100) according to claim 1, wherein the coating device (100) has a device for temperature compensation (122) of at least one temperature-dependent property of the coating medium.

10. A system (1000) having a coating device (100) according to claim 1 and a component (10) which has a cell cluster (16) having several energy storage cells (18), a cell contacting feature (20) and a summation current connector (21), wherein the coating device (100) is configured to coat only partial areas of the energy storage cells (18), only cell shoulder areas (22) of the energy storage cells (18), with the coating medium, wherein the cell contacting feature (20) and the summation current connector (21) are essentially free of the coating medium after the coating.

11. The system (1000) according to claim 10, which further has a drying device (124) for drying the coating medium.

12. An energy storage medium (14) for a vehicle, the energy storage medium (14) having at least one cell cluster (16) having several energy storage cells (18), a cell contacting feature (20) and a summation current connector (21), wherein partial areas of the energy storage cells (18), only cell shoulder areas (22) of the energy storage cells (18), are coated with a coating medium which is applied by a coating device (100) according to claim 10.

13. The energy storage medium (14) according to claim 12, the energy storage medium (14) further having a casing (26) in which the at least one cell cluster (16), the cell contacting feature (20) and the summation current connector (21) are at least partially disposed, and a stabilizing medium (28) which is inserted in the casing (26) in order to stabilize the energy storage medium (14), wherein the coating medium acts as an adhesive agent between the energy storage cells (18) and the stabilizing medium (28) in order to thus prevent or at least minimize a peeling of the stabilizing medium (28) off the energy storage cells (18) during a high-performance operation of the energy storage medium (14).

14. The energy storage medium (14) according to claim 13, wherein the stabilizing medium (28) has a reactive foam or resin.

15. A method for applying a coating medium on a component (10), the method including the steps of registering (S1) at least one geometrical property (h) of the component (10) by means of a registration feature (102) and of only selectively coating (S2) areas of a component surface of the component (10) via the coating medium as a function of the at least one geometrical property and as a function of at least one predetermined component-dependent coating criterion based on a geometrical property via at least one coating nozzle (104) displaceable in relation to the component (10).
